(19) United States
(12) Patent Application Publication
(10) Pub. No.: US 2013/0313062 A1
(43) Pub. Date: Nov. 28, 2013

(54) LIQUID FRICTION CLUTCH

(71) Applicant: Thomas Buchholz, Stockach (DE)

(72) Inventor: Thomas Buchholz, Stockach (DE)

(73) Assignee: BORGWARNER INC., Auburn Hills, MI (US)

(21) Appl. No.: 13/982,861

(22) PCT Filed: Jan. 30, 2012
(86) PCT No.: PCT/US12/23084

§ 371 Date: Jul. 31, 2013

(30) Foreign Application Priority Data
Feb. 14, 2011 (EP) 11001192.1

(51) Int. Cl. F16D 35/02

(52) U.S. Cl. CPC F16D 35/027
USPC 192/58.7

(57) ABSTRACT

The invention relates to a liquid friction clutch (1) having a housing (2, 3), having a clutch disk (4) which is rotatable relative to the housing (2, 3) and which is rotationally fixedly arranged on an end (5) of a shaft (6) which is mounted centrally within the housing (2, 3), which shaft (6) bears on its other end (8) a driveable active element (7); having a working chamber (9) between the housing (2, 3) and the clutch disk (4); having a storage chamber (10) for clutch fluid; having a supply duct (11) which leads from the storage chamber (10) to the working chamber (9); and having a stationary clutch part (13) relative to which the housing (2, 3) is rotatable, characterized by a supply pump element (14) which is rotatable relative to the housing (2, 3), which supply pump element is rotationally fixedly arranged on the shaft (6) and which supply pump element, with the housing (2, 3), defines a shear gap (12); and by a valve (17) which is arranged in the supply duct (11).

The invention relates to a liquid friction clutch according to the preamble of claim 1.

A liquid friction clutch of said type is known from EP 1 731 787 B1, the content of disclosure of which is hereby incorporated by explicit reference in the content of disclosure of the present application.

It is an object of the present invention to provide a liquid friction clutch of the type specified in the preamble of claim 1 by means of which it is possible in a simple manner to increase the efficiency of the clutch.

Said object is achieved by means of the features of claim 1.

By means of the provision of a rotatably mounted supply pump element which, with the housing, defines a shear gap, it is made possible in a simple manner, by utilizing a rotational speed difference between the pump element and the housing or the primary side of the liquid friction clutch, to generate a variable volume flow from the storage chamber into the working chamber.

The particular advantages of the liquid friction clutch according to the invention include firstly that only a small quantity of clutch fluid is required, because on account of the above-explained arrangement, an active feed pump is formed in the oil reservoir, which with regard to the clutch fluid quantity is advantageous over the known utilization of centrifugal forces for filling the working chamber.

Furthermore, the response behavior of the liquid friction clutch according to the invention is faster on account of the smaller clutch fluid component.

An extremely compact design is also generated because the outer diameter of the storage chamber or of the reservoir can be made larger than the inner diameter of the working chamber.

In summary, it can therefore be stated that, owing to the fact that the supply pump element rotates at a secondary rotational speed (rotational speed of the shaft or active element) and strips clutch fluid from the housing, excellent clutch performance can be achieved.

The subclaims relate to advantageous refinements of the invention.

The clutch performance can furthermore be improved by virtue of a return feed pump being provided which rotates at the primary rotational speed (housing rotational speed) and which, owing to its arrangement adjacent to the clutch disk, strips clutch fluid from the clutch disk.

Further details, advantages and features of the present invention will emerge from the following description of exemplary embodiments on the basis of the drawing, in which:

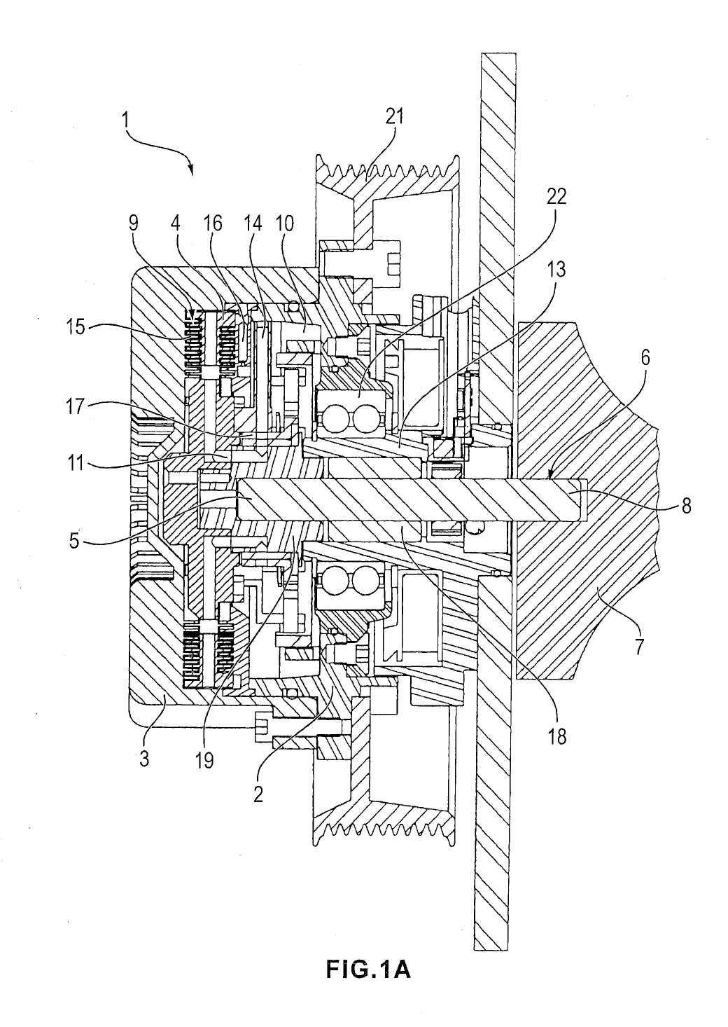

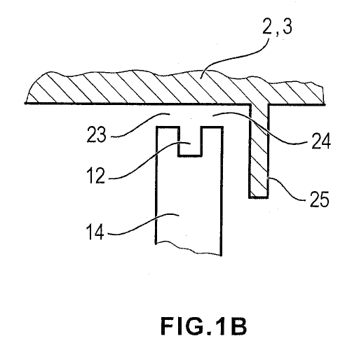

FIG. 1A shows a sectional illustration of a liquid friction clutch according to the invention, and

FIG. 1B shows a schematically highly simplified illustration of a part of a pump element for explaining a shear gap.

FIG. 1A shows a sectional illustration of a liquid friction clutch 1 according to the invention which has a housing which is constructed in the conventional way from a housing body 2 and a cover 3.

Arranged in the housing 2, 3 is a clutch disk 4 which is rotatable relative to the housing 2, 3. Here, the clutch disk 4 is rotationally fixedly arranged on an end 5 of a shaft 6 which is mounted centrally within the housing 2, 3. Fixed to the other end 8 of the shaft is a drivable active element 7 which is illustrated in schematically simplified form and which may be designed for example as a pump wheel or as an impeller.

A working chamber 9 is arranged between the housing 2, 3 and the clutch disk 4, which working chamber 9, as can be seen from FIG. 1A, has working gaps 15 which make a transmission of torque possible on account of a shear action on the clutch fluid supplied to the working chamber 9.

Furthermore, a storage chamber 10 for said clutch fluid is provided, with a supply duct 11 leading from the storage chamber 10 to the working chamber 9 and thus forming the supply.

As can be seen in particular from FIG. 1A, a return pump system or a return feed pump 16 is also provided which serves for returning the clutch fluid from the working chamber 9 to the storage chamber 10. As can be seen from the figure, the return feed pump 16 is arranged adjacent to the clutch disk 4. The return feed pump 16 is arranged on the housing 2, 3 and therefore rotates at the primary rotational speed. As a result of the arrangement of the adjacent clutch disk 4, the return feed pump 16 therefore strips clutch fluid from the clutch disk, which in conjunction with a supply pump element 14 to be described below considerably improves the efficiency of the liquid friction clutch 1 according to the invention.

A drive element 21, such as for example a belt pulley, is also connected to the housing 2, 3. The liquid friction clutch 1 also has a stationary clutch part 13 on which the housing 2, 3 is mounted via a main bearing 22. The shaft 6 is mounted on the stationary clutch part 13 via the secondary bearing 18.

As is also shown by FIG. 1A, the liquid friction clutch 1 according to the invention is characterized by the provision of a supply pump element 14 which is rotationally fixedly mounted on the shaft 6 and which is therefore rotatable relative to the housing 2, 3 but not relative to the shaft 6. An alternative mounting of the supply pump element 14, for example on the stationary part 13, is however likewise possible in principle.

In the illustrated example, the supply pump element 14 has at its radial outer edge a shear gap 12 which, according to the detail illustration in FIG. 1B, is sealed off with respect to the housing 2, 3 by means of sealing gaps 23 and 24. By means of this arrangement, a variable feed pump is formed which, as already explained in the introduction, permits a volume flow of clutch fluid from the storage chamber 10 to the working chamber 9 on account of a rotational speed difference to be generated between the supply pump element 14 and the housing 2, 3. Here, it should be emphasized that the arrangement shown on an enlarged scale in FIG. 1B is not restricted to a radial alignment of the shear gap 12. Furthermore, an axial configuration of the shear gap 12 together with corresponding sealing gaps relative to the axially adjacent housing part 25 would also be conceivable.

The volume flow from the storage chamber 10 into the working chamber 9 is generated by the above-explained supply pump element 14 in conjunction with the explained shear gap 12. Here, the supply pump element 14 and the shear gap 12 form a variable feed pump, the operating principle of which is based on the rotational speed difference explained in the introduction.

As is also shown in FIG. 1A, there is arranged in the supply duct 11 a valve 17 which, together with the supply pump element 14 which rotates at the secondary rotational speed, regulates the inflow into the working chamber 9. Here, the valve 17 can be actuated by means of an actuating device known per se, such as is described for example in EP 1 045 163 B1, the content of which is hereby incorporated in the content of disclosure of the present application.

In addition to the written disclosure of the invention, reference is hereby explicitly made to the diagrammatic illustration thereof in FIGS. 1A and 1B.

### LIST OF REFERENCE SYMBOLS

1 Liquid friction clutch
2, 3 Housing (2: housing body, 3: cover)
4 Clutch disk
5 End of the shaft 6
6 Shaft
7 Active element (for example pump wheel, impeller etc.)
8 Second end of the shaft 6
9 Working chamber
10 Storage chamber
11 Supply duct
12 Shear gap
13 Stationary clutch part (pump housing)
14 Supply pump element
15 Working gap
16 Return feed pump
17 Valve
18 Secondary bearing
19 Valve support
21 Drive element, in particular belt pulley on housing 2, 3
22 Main bearing
23, 24 Sealing gaps
25 Housing part

1. A liquid friction clutch (1)
having a housing (2, 3),
having a clutch disk (4)
which is rotatable relative to the housing (2, 3) and
which is rotatably arranged on an end (5) of a shaft (6) which is mounted centrally within the housing (2, 3), which shaft (6) bears on its other end (8) a driveable active element (7);
having a working chamber (9) between the housing (2, 3) and the clutch disk (4);
having a storage chamber (10) for clutch fluid;
having a supply duct (11) which leads from the storage chamber (10) to the working chamber (9); and
having a stationary clutch part (13) relative to which the housing (2, 3) is rotatable,
characterized
by a supply pump element (14) which is rotatable relative to the housing (2, 3),
which supply pump element is rotationally fixedly arranged on the shaft (6) and
which supply pump element, with the housing (2, 3), defines a shear gap (12); and by a valve (17) which is arranged in the supply duct (11).

2. The liquid friction clutch as claimed in claim 1, wherein the shear gap (12) is delimited with respect to the housing (2, 3) by sealing gaps (23, 24).

3. The liquid friction clutch as claimed in claim 1, characterized by a return feed pump (16) for returning clutch fluid from the working chamber (9) to the storage chamber (10).

4. The liquid friction clutch as claimed in claim 3, characterized in that the return feed pump (16) is arranged adjacent to the clutch disk (4).
